(19) United States
(12) Patent Application Publication
(10) Pub. No.: US 2012/0055416 A1
(43) Pub. Date: Mar. 8, 2012

(54) Long-handled horse grooming tool

(75) Inventor: Frances Ellen Forgues, Cumberland (CA)

(73) Assignee: Frances Ellen Forgues, Cumberland (CA)

(21) Appl. No.: 13/135,388

(22) Filed: Jul. 5, 2011

(30) Foreign Application Priority Data
Sep. 8, 2010 (CA) 2,715,612

(51) Int. Cl. A01K 13/00

(52) U.S. Cl. 119/633

(57) ABSTRACT

This is a tool for grooming livestock, horses in particular. This invention is comprised of a broom-head equipped with multiple flexible rake tines along its top edge, the tine heads facing 180 degrees opposite to the bristle ends. The broom-head is fitted with a threaded hole that allows a solid or telescoping handle to be attached. The telescoping handle is similar to handles found on commercially available floor mops. It can be extended or retracted longitudinally, and can be locked in place at any point along its length. The handle can be equipped with one or more grips to provide a comfortable, secure hand-hold for the user. The user selects the desired head (bristles or tines) by rotating the handle 180 degrees.

### BACKGROUND OF INVENTION

Horses must be groomed immediately before and after they are ridden or worked in harness in order to protect their skin from galling and to keep them healthy and presentable. Historically horses have been cleaned with hand-held tools, principally brushes and curry combs. Some of these tools have employed short teeth, usually no longer than 1 cm ( 1/2 in.), which are made of steel, rubber or plastic. The use of hand-held tools to remove mud, manure, hair, dander etc. from a horse's coat requires that the person grooming the horse must stand in close proximity to the animal. In this position the groom is exposed to the dirt, hair, dust and possible allergens that are produced during the cleaning of the horse. The groom is also placed in a potentially dangerous position should the horse become frightened or unruly during the grooming process.

Horses are usually groomed dry rather than being bathed. The act of cleaning a dry horse with hand-held tools requires considerable time and effort. It also requires that the groom be physically fit enough to repeatedly deliver the brushing motions, to reach up repeatedly in order to clean a tall horse, and to stoop down repeatedly in order to brush an animal's legs and underbelly. All of the effort required for traditional grooming is in the form of direct force supplied by the groom's hand, arms, shoulders and back. Hand-held brushes are difficult to use against the grain of the hair; therefore every stroke of the grooming process must be done in a head-to-tail direction. Grooming horses with traditional hand-held tools is a physically demanding, dirty, and potentially dangerous job that exposes the groom to dust, dirt and allergens. This work is particularly difficult for anyone with limited mobility in their shoulders, back or arms.

### BRIEF SUMMARY OF INVENTION

This invention involves a brush head, the top edge of which is fitted with plastic rake tines that face opposite to the direction of the brush's bristles. The brush head is mounted on a solid or telescoping handle.

This invention allows people to groom dry horses more quickly, more efficiently, more safely and with less effort than can be done using traditional hand-held grooming tools, which are generally fitted to the palm of the hand or have very short handles. Traditional palm-fitting brushes produce dirt, hair and dust directly at the groom's hands, making contact with the detritus unavoidable. The handle of this invention allows the groom to avoid most of the resulting hair and dirt, thereby reducing contact with allergens and keeping the groom cleaner.

The long handle gives the groom a much greater reach lengthwise, upwards and downwards, thus requiring much less bending and reaching than is necessary when using traditional tools. It allows the groom to easily reach any part of even the tallest horses without having to resort to standing on boxes or steps. The handle also allows the groom to stand at a safe distance from the horse, thereby helping to prevent injury by an excited animal.

The handle's length allows each sweep of this tool to cover far more area than hand-held brushes can, thereby reducing the time and physical effort it takes to clean a horse. It also allows the groom to bathe a horse more efficiently and to stay drier during that process.

This tool allows the lever-and-fulcrum effect of the long handle and the groom's arms to multiply the force supplied by the groom, thus delivering pressure to the tines and bristles with less effort than when using traditional tools. This multiplied force also allows a person to easily groom against the lay of the hair, facilitating the cleaning process in a way that traditional hand-held tools cannot achieve.

The rake tines of this invention are much longer than the teeth used in previous tools. The plastic tines massage the horse's skin, loosen shedding hair very effectively, and raise dirt and dandruff from the animal's coat. During the spring shedding season the use of the tines allows the groom to shed out a horse with considerable ease, a chore that has been onerous in the past.

Multiple test horses exhibited enjoyment while being groomed with the rake tines. These animals demonstrated relaxation and engagement during the grooming process by stretching their necks, tipping their heads to the side, stretching and smacking their lips, and moving their bodies into positions that aligned itchy areas with the tines.

The large brush head allows the groom to sweep away loosened dirt and hair, covering far more area with each pass than can traditional brushes, which must be smaller to be held in the hand. It thus requires less effort from the groom's arms, shoulders and back. Using this invention a groom rarely needs to lift his/her hands above shoulder height or below waist height, and does not need to bend over in order to clean an animal's legs and belly. With this invention anyone, including people with limited mobility of the back, arms or shoulders, can groom their animals faster, more safely and more easily than when using traditional grooming tools.

### OBJECTS OF INVENTION

The objects of this invention are to:

provide a new way to groom dry horses;

provide a safer way to groom dry horses;

provide a way to groom dry horses that is physically easier for the groom than using traditional hand-held tools;

provide a tool for grooming dry horses that allows the groom to avoid the resulting dust, dirt and hair;

provide a method of grooming dry horses that is faster and more efficient than that of using traditional grooming tools;

provide a method of grooming dry horses which involves the use of a brush head (which may be equipped with grooming tines) mounted to a long handle.

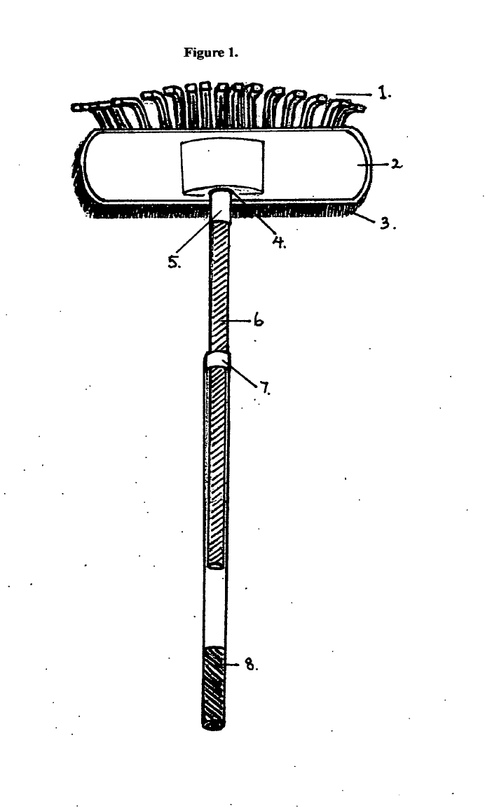

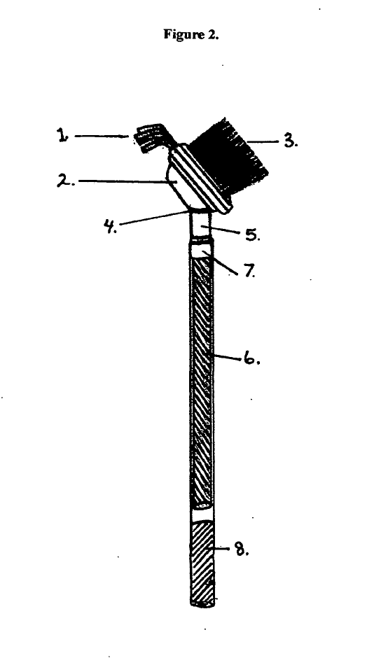

### DESCRIPTION OF FIG. 1 AND FIG. 2

FIG. 1 is a view of the back of the long-handled horse-grooming tool, showing the main body (#2), being a brush equipped with bristles (#3) and having flexible rake tines (#1) mounted to the uppermost edge of the main body, the direction of the distal end of the tines being set opposite to the direction of the distal end of the bristles. The main body has a threaded opening (#4) into which is inserted the threaded coupling (#5) of the handle (#6). The handle (#6) can be lengthened or shortened by twisting the locking device (#7), lengthening or retracting the handle (#6), and then twisting the locking device in the opposite direction. The handle (#6) is shown with a single hand grip (#8) for the comfort of the groom.

FIG. 2 is a view from the right side of the long-handled horse-grooming tool. This figure demonstrates the rake tines (#1), which are integral to the face of the main body (#2), and further demonstrates the direction of the distal ends of the tines set opposite to the direction of the distal end of the bristles. The telescoping handle (#6) is fully retracted in this view, which shows the position of the threaded coupling hole in the main body (#4), the correspondingly threaded coupling head (#5) on the handle (#6), the locking device (#7), and the hand grip (#8).

### DETAILED DESCRIPTION OF INVENTION

The main body, bristles and tines of this tool are of molded plastic, with the brush head, threaded opening and tines being formed simultaneously. The bristle bundles are added to the molten plastic, and the handle (many forms of which are already commercially available for use as mop, squeegee or paint roller handles) is then attached.

In this invention the brush head (#2, FIGS. 1 and 2) is made of plastic, is rectangular, and measures approximately 25 cm (9 3/4 in.) long by 7 cm (2 3/4 in.) wide. The back of the brush head is molded with a threaded opening (#4, FIGS. 1 and 2) measuring approximately 1.6 cm ( 5/8 in.) in diameter, designed to allow the attachment of a handle. The synthetic or natural fiber bristles (#3, FIGS. 1 and 2) are set in the face of the brush head and can be of varying lengths, textures, compositions and angles.

The fifteen flexible plastic rake tines (#1, FIGS. 1 and 2) range in height from approximately 2 cm ( 13/16 in.) to approximately 4 cm (1 5/8 in.), are semi-circular in cross-section and approximately 7 mm ( 5/16 in.) in diameter. Each tine has a 90-degree bend and each tine head measures approximately 3 cm (1 1/4 in.) long. The tines are placed linearly along the uppermost edge of the brush head and radiate in an arc of approximately 45 degrees. The direction of the distal end of the tines is set opposite to the direction of the distal end of the bristles, so that the tines face away from an animal being groomed with the bristles. Slight changes in the size or number of tines will not significantly alter the function of this tool.

The long handle (#6, FIGS. 1 and 2) is critical to this invention. It can be solid or telescoping. The telescoping handle is more practical than a solid handle, as it lets the groom adjust his/her distance from the horse at will and then lock the handle in position by twisting the locking device (#7, FIGS. 1 and 2). The telescoping handle also makes the tool more compact and therefore easier to store. The handle is equipped with a threaded coupling (#5, FIGS. 1 and 2) which screws tightly into the receiving opening (#4, FIGS. 1 and 2) on the brush head. The handle is approximately 2.5 cm (1 in.) wide and can range from approximately 75 cm (30 in.) to approximately 125 cm (50 in.) in length. The handle can be equipped with one or more hand grips (#8, FIGS. 1 and 2) for a comfortable and secure grip. It can be made of plastic, aluminum, steel or other strong and lightweight materials.

### PRIOR ART

### Canadian Patents

125340 Horse brush Press, George F. (USA) Apr. 26, 1910.

118963 Horse brush Menzies, George (USA) Jun. 15, 1909

64626 Horse brush Marcotte, Honore (Canada) Oct. 28, 1899

44701 Horse brush Giesecke, Sophia (USA) Nov. 15, 1893

358351 Horse cleaning apparatus Walters, Frederick Jun. 9, 1936

### U.S. Patents

U.S. Pat. No. 7,926,492 Direct application horse and livestock brush having flow regulator assembly Hurwitz, Marni Apr. 19, 2011

U.S. Pat. No. 7,694,687 Direct application brush for horses and livestock that releases active ingredients Hurwitz, Marni Apr. 13, 2010

U.S. Pat. No. 6,510,816 Easy clean equine body brush Ehrmann Jan. 28, 2003

U.S. Pat. No. 5,960,745 Horse grooming device Boyland, Leslie Oct. 5, 1999

U.S. Pat. No. 4,343,265 Brush for grooming animals Belschner Aug. 10, 1982.

All of the patents listed above involve hand-held brushes in a variety of forms. All require the groom to stand in close proximity to the animal being cleaned, thus exposing the groom to the resulting dirt, hair and dander, and placing that person in a potentially dangerous position should the horse become unruly. All of these tools require that the groom supply the totality of the energy required through the use of direct force produced by the groom's back, shoulders and arms. All of the above inventions cause the groom to stoop down and reach up repeatedly. Because these tools are hand-held rather than being mounted on a long handle, they cover a relatively small area with each stroke, using more time and energy than required when grooming with a long-handled brush which is also equipped with relatively longer grooming tines rather than shorter teeth.

1. A brush assembly for the purpose of grooming, shedding and massaging livestock, primarily horses, including in combination: a body member which demonstrates a bristle-carrying surface, the outer aspect of said body member being equipped with a coupling such as a threaded opening, which is designed to allow the attachment of a handle; a multiplicity of bristles extending from the inner aspect of said body member; multiple molded plastic grooming tines integral to the uppermost edge of the main body and projecting from said body member in a direction opposite to that of said bristles; a solid or telescoping handle, fitted with a coupling designed to attach to the brush head, and demonstrating one or more hand grips.

2. A brush assembly as stated in claim 1 wherein a plurality of grooming tines:
are linearly aligned along the uppermost edge of the body member;
may radiate in an arc from the uppermost edge of the body member;
are made of flexible plastic;
demonstrate distal ends set in a direction opposite to the distal ends of said brush bristles;
demonstrate a single bend at one or various predetermined angles;
may be of uniform or varying lengths.

3. A brush assembly as stated in claim 1 whose bristles may be:
formed of natural or synthetic fibers;
of uniform or varying lengths;
set at a uniform angle or at varying angles;
of uniform or varying textures.

4. A method of grooming dry livestock, primarily horses, whereby the grooming tool, namely a brush as described in claim 3, is mounted on a handle which can be either telescoping or solid in nature, and may demonstrate grooming tines as described in claim 2.
